(19) United States
(12) Patent Application Publication
(10) Pub. No.: US 2023/0207158 A1
(43) Pub. Date: Jun. 29, 2023

(54) WIRES, STRANDS, RIGID AND FLEXIBLE ROPES HAVING HIGH ELECTRIC, PHYSICO-CHEMICAL AND ENVIRONMENTAL PERFORMANCES

(71) Applicants: Domenico Barbieri, San Ferdinando (RC) (IT); Vincenzo Tagliaferri, Naples (IT); Nadia Ucciardello, Camigliano (CE) (IT)

(72) Inventors: Domenico Barbieri, San Ferdinando (RC) (IT); Vincenzo Tagliaferri, Naples (IT); Nadia Ucciardello, Camigliano (CE) (IT)

(21) Appl. No.: 17/999,186

(22) PCT Filed: May 24, 2021
(86) PCT No.: PCT/EP2021/063753

§ 371 Date: Nov. 17, 2022

(30) Foreign Application Priority Data
May 26, 2020 (IT) 102020000012319

(51) Int. Cl. H01B 13/22; H01B 1/02; H01B 13/00

(52) U.S. Cl. CPC H01B 13/22; H01B 1/02; H01B 13/0036; H01B 13/0016; H01B 13/02

(57) ABSTRACT

Here described is the production of wires, strands, rigid ropes and flexible ropes having high electric, physico-chemical and environmental performances for the purposes of electrical conduction, enhanced through multilayer deposition containing graphene, and a method for their preparation. Each single wire, strand, rope and/or cable according to the present invention is produced through electrochemical deposition processes and/or of a different nature, in order to potentiate electric, physico-chemical and environmental performances (in particular electric conductivity) and the resistance to the thermal and corrosive actions of said wire, strand, rope and/or cable, facilitating furthermore subsequent manufacturing processes and making the connection of cable terminals and/or anchors less critical. Said wire, strand, rope and/or cable obtained at the end of the manufacturing process can be used bare for the purposes of electrical conduction or constitute the core of insulated cables to be used in the automotive and energy sectors.

### FIELD OF THE INVENTION

The present invention relates to wires, strands, rigid and flexible ropes having high electric, physico-chemical and environmental performances for the purposes of electrical conduction, enhanced through multilayer deposition containing graphene, and a method for their preparation.

Each single wire, strand, rope and/or cable according to the present invention is produced through electrochemical deposition processes and/or of a different nature, in order to potentiate electric, physico-chemical and environmental performances (in particular electric conductivity) and the resistance to the thermal and corrosive actions of said wire, strand, rope and/or cable, facilitating furthermore subsequent manufacturing processes and making the connection of cable terminals and/or anchors less critical.

Said wire, strand, rope and/or cable obtained at the end of the manufacturing process can be used bare for the purposes of electrical conduction or constitute the core of insulated cables to be used in the automotive and energy sectors.

### BACKGROUND OF THE INVENTION

An electrical cable is an electrical component consisting of a set of several coiled conductive wires wrapped around each other and coated with one or more layers of material acting as electrical insulator and protection (sheath). Largely used in the electrotechnical, the electronic and the telecommunications fields, its function is to conduct electric current for energy transfer (for example in the electrical systems or electrical networks) or to allow the exchange of data and information at a distance. The set of cables and terminals suitably interconnected with each other within a given infrastructure, typically referred to as the electrical network or electrical system, is called “wiring”.

In almost all the electrical cables, metals having a low electrical resistance such as silver, copper or aluminium are used for the production of the conductive wires. The latter have a variable thickness according to the current capacity and whether a higher resistance to the mechanical stress or greater flexibility is required; they generally have a circular section, but can also be flattened or shaped and are typically joined by a helical and/or spiral winding process called stranding and/or cording.

Cables are articles essentially developed in length, used for connecting two points, in order to transfer from one to the other electrical power or information through electromagnetic fields. In the first case, we speak of energy cables, in the second of telecommunications cables.

### Energy Cables

The energy cables are made of one or more elements called cores. Based on the number of cores they are called unipolar, bipolar, tripolar, quadripolar, etc, and their number is determined by the particular electrical system they belong to. Each core is made of a conductor (of copper, aluminium or its alloy) and typically its coated with an insulator. The section of the conductor is a function of the electric current with which the electric energy is transmitted.

The bigger the section of the conductor, the more difficult it is to move the cable during its installation and use. When it is necessary to improve its flexibility, the conductor is made, instead of a single wire or with few wires having a large section stranded together (rigid conductor), with many thin wires stranded together (flexible conductor). For each section and format of the conductor (number and section of the single wires) of a certain type of cable, the manufacturer fixes the minimum bending radius below which one cannot go during the laying or use of the cable itself, in order not to compromise its integrity.

The insulator can be made of textile material, paper (mainly impregnated with special insulating oils), rubber, PVC-based compounds, polyethylene or other special synthetic materials. The thickness and the technical characteristics of the insulator must be such as to guarantee that the different conductors never come into contact with each other and that, according to the insulating material used, they are far enough apart so that the different electrical potential that exists between each of them and the surrounding environment does not give rise to an electric discharge.

WO2015/041439 reports a coaxial cable, which has a metal wire as a core, in which said metal wire is covered:
With a first layer of “composite plating” having a mixture of a homogeneous or heterogeneous metal and a first layer of graphene; and subsequently
With a second layer of graphene placed on the surface of the layer of “composite plating”.

CN202384469U mentions a cable for radio frequency characterized by the fact that the internal conductor is made of an aluminium core and externally a layer of copper is deposited on the peripheral area of the aluminium core.

WO2014/141071 describes a method for preparing metal foams coated (by means of an electrodeposition process) with a metal matrix and graphene.

In the prior art, wires, strands, ropes and/or conductor cables object of the present invention are not described or suggested.

### DESCRIPTION OF THE INVENTION

The present invention relates to the production of wires, strands, rigid ropes and flexible ropes having high electric, physico-chemical and environmental performances for the purpose of electrical conduction, enhanced through multilayer deposition containing graphene, and a method for their preparation.

Each single wire, strand, rope and/or cable according to the present invention is produced through electrochemical deposition processes and/or of a different nature, in order to potentiate electric, physico-chemical and environmental performances (in particular electric conductivity) and the resistance to the thermal and corrosive actions of said wire, strand, rope and/or cable, facilitating furthermore subsequent manufacturing processes and making the connection of cable terminals and/or anchors less critical. Said wire, strand, rope and/or cable obtained at the end of the manufacturing process can be used bare for the purpose of electrical conduction or constitutes the core of insulated cables to be used in the automotive and energy sectors.

In particular, in accordance with the present invention, by strand and/or rope it is meant a separate element consisting of several wires arranged longitudinally and wound together with regular helixes (called “concentric”) or helical and/or irregular spiral (called “bunched”), in turn it can also be considered as a building element of the flexible ropes in the case of formations called “pre-stranded” (ropes made of the helical joining of several strands and/or ropes, instead of the strands and/or ropes arranged in “bunched” formation, of the reunification of single wires generally thin in helical and/or irregular spiral shape).

It is therefore the object of the present invention an electric conductor represented by a single wire or a strand or a rigid rope (obtained by joining single wires having a diameter of between 0.1 mm and 5 mm) or flexible (in “pre-stranded formations” or “bunched”, as described above), obtained through the following processing phases:

### Phase 1—Unrolling the Metal Wire Spool

The metal wires with circular or shaped section are unrolled from a spool through a special static or dynamic unrolling mechanism. Said unrolling mechanism can relate to a single metal wire or a bundle of metal wires (being formed by 8-wires, 16 wires, etc.). The metal wires:
they generally have a circular section, with a diameter between 0.1 mm and 5 mm, but they can also have a trapezoidal section;
they are made by drawing a metal chosen from: aluminium, silver, nickel, gold, copper and/or their alloys; preferred is aluminium. During the unrolling of the spool, the wire must maintain a tension controlled or not, but still variable within a predefined range.

### Phase 2—Preparing the Metal Wires

The metal wires of step 1, depending on the peculiarities of the product to be made, can be prepared through suitable annealing and/or cleaning and/or stranding and/or cording mechanisms described below:
2A—annealing: the metal wires undergo from one to three thermal cooking cycles, each characterized by the following temperatures and by the following time intervals:
   i) cooking from room temperature (about 20° C.) up to a maximum of 400° C. for a period of time between 1 hour and 4 hours;
   ii) maintaining the temperature reached for a period of time between 2 hours and 20 hours;
   iii) cooling until room temperature is reached.
2B—cleaning: the metal wires are treated with specific cleaning solutions (such as for example a whole degreaser of petroleum derivation) and subsequently subjected to abrasion and/or drying with textile materials or air, to remove any further residue on the surface of said metal wires;
2C—stranding and/or cording: the metal wires are subjected to a mechanical rejoining process that wraps them longitudinally to each other so as to make them a single flexible filiform organ with a generally circular section, as regular as possible.
   Phase 3—Coating the Metal Wires and/or the Strands and/or the Ropes

The metal wires of phase 1 and/or the metal wires and/or the strands and/or the ropes of step 2 are coated through subsequent steps:
Step 1—the metal wires and/or the strands and/or the ropes are coated with a first metal layer, deposited using a physical deposition technique (PVD/physical vapor deposition) or with a chemical deposition technique (CVD/chemical vapor deposition) as described in Adv. Mater. 2000, 12, No. 9;
Step 2—on the first metal layer of Step 1 a second metal layer (or its alloys) and graphene is deposited/stratified, using the electrodeposition technique described in WO2014/141071, wherein the metal associated with the graphene may the same or different from the one used in Step 1;
Step 3—on the second layer of metal and graphene of Step 2 a third metal layer (or its alloy) is deposited/stratified through a further process of electrodeposition as described in WO2014/141071, or a vapor chemical or physical deposition process through the PVD or CVD process as described in http://www.maq-data.com/dettagli-tecnici/introduzione-ai-film-polimerici/; Journal of Materials Chemistry C Volume 4 Number 37, 7 October 2016, Pages 8585-8830; e/o Adv. Mater. 2000, 12, No. 9.
   The metallic material of the first, second and third layer is selected from: aluminium, silver, nickel, gold, copper and/or their alloys; the metal of the first layer can be the same or different from the metal of the second layer, which in turn can be the same or different from the metal of the third layer.
   Phase 4—Depositing Polymeric Material and/or Chemical Binder Resins.

The metal wires and/or strands and/or the electrodeposited ropes obtained at the end of phase 3, can have a surface excessively rough or in any case not suitable for the purposes of any subsequent processing steps. For this reason on said metal wires and/or strands and/or electrodeposited ropes, a material belonging to the category of polymers and/or chemical binder resins is deposited/sprayed to facilitate the subsequent processing steps; depending on the final destination of the wires and/or the strands and/or the ropes, said material may contain graphene and can also be chosen to facilitate its electro-conductivity or, on the contrary, its insulation.

Depending on the subsequent use of the metal wire and/or the strand and/or rope:
The phase 2 and 3 can occur in the described sequence or merged, or with an inverse sequence;
Step 3 of phase 3 and phase 4 are not always necessary and can coexist or be alternative to each other.

Phases 2 and 3 can be merged, for example, when:
i) in order to obtain certain electromechanical characteristics, the metal wire is first subjected to the cleaning of phase 2B, then electrodeposited as described in phase 3, subsequently annealed as described in phase 2A, and finally stranded and/or corded as described in phase 2C;
ii) the metal wire is first subjected to the cleaning of phase 2B, then electrodeposited as described in phase 3, subsequently stranded and/or corded as described in phase 2C and finally annealed as described in phase 2A.

The phases described above can therefore relate to single wires, bundles of parallel wires or also strands and/or pre-stranded and/or bunched rigid or flexible ropes.

The section of a strand and/or of a rope is generally comprised between 0.05 mm² and 1,200 mm² and can be realized with a number of wires very variable depending on its electromechanical characteristics. While, for a particular section, the electrical conductivity is poorly affected by the number of wires, on the contrary, the flexibility and the fatigue resistance are very much affected and for this reason the number of wires can vary from a minimum of 2 up to thousands of wires, which are arranged in very different configurations depending on the final use for which the strands and/or ropes are intended.

Phase 5—Optional—Coating with Insulating Material

The wires and/or strands and/or ropes obtained in the preceding phases can be coated with one or more layers of insulating polymeric and/or insulating material, thus obtaining a cable that can be used in the industrial, automotive, energy, naval and/or aerospace sectors and having better characteristics of electrical conductivity, lightness, resistance to chemical and physical actions and environmental impact compared to current cables.

In the following Table 1 are compared:
The wire obtained with the process according to the present invention;
The aluminium wire currently commercially available;
The copper wire currently commercially available;

with respect to the following parameters:
electrical conductivity (measured in IACS);
wire section (measured in mm²) at the same electrical conductivity;
weight of the wire (measured in Kg) at the same electrical conductivity.

TABLE 1

| | | Wire currently on | Wire |
|---|---|---|---|
| | | the market in | currently on |
| | Wire of the | aluminium and | the market in |
| | present invention | its alloys | copper |
| Electrical | 70-100 | 57-63 | 90 |
| conductivity | | | |
| indicator (IACS) | | | |
| Section | 100-130 | 158-168 | 90 |
| indicator (mm² | | | |
| at the same | | | |
| electrical | | | |
| resistance) | | | |
| Weight indicator | 50-75 | 47-53 | 100 |
| (Kg at the same | | | |
| electrical | | | |
| resistance) | | | |

The data reported in Table 1 show that the wire obtained with the preparation procedure according to the present invention, appears to have:
approximately 40% higher electrical conductivity than aluminium wire currently on the market;
approximately 10% higher electrical conductivity than copper wire currently on the market;
a smaller section (at the same electrical conductivity) of about 25% compared to the aluminium wire currently on the market;
a smaller section (at the same electrical conductivity) of about 10% compared to the copper wire currently on the market;
a lower weight (at the same electrical conductivity) of about 30% compared to the aluminium wire currently on the market.

1. A process for the preparation of an electrical conductor comprising the following processing phases:
Phase 1—unrolling the metal wire spool;
Phase 2—preparing the metal wires; wherein said phase 2 comprises the following processing steps:
2A—annealing: the metal wires undergo from one to three thermal cooking cycles, each characterized by the following temperatures and by the following time intervals:
i) cooking from room temperature (about 20° C.) up to a maximum of 400° C. for a period of time between 1 hour and 4 hours;
ii) maintaining the temperature reached for a period of time between 2 hours and 20 hours;
iii) cooling until room temperature is reached;
2B—cleaning: the metal wires are treated with a cleaning solution and subsequently subjected to abrasion and drying with textile materials or air, to remove any further residue on the surface of said metal wires;
2C—stranding and/or cording: the metal wires are subjected to a mechanical rejoining process that wraps them longitudinally to each other so as to make them a single flexible filiform organ with a generally circular section, as regular as possible;
Phase 3—coating the metal wires and/or of the strands and/or of the ropes, wherein said phase comprised the following steps:
Step 1—the metal wires and/or the strands and/or the ropes are coated with a first metal layer, deposited using a physical deposition technique (PVD) or with a chemical deposition technique (CVD);
Step 2—on the first metal layer of step 1 a second metal layer and graphene is deposited, using the electrodeposition technique;
Step 3—on the second layer of metal and graphene of Step 2 a third metal layer is deposited using the physical vapor deposition (PVD), chemical vapor deposition (CVD) or electrodeposition procedure; and
wherein:
the metal material of the first, second and third layer is selected from the group consisting of: aluminium, silver, nickel, gold, copper and/or their alloys;
the metal of the first layer can be the same or different from the metal of the second layer, which in turn can be the same or different from the metal of the third layer;
Phase 4—depositing polymeric material and/or chemical binder resins: on metal wires and/or strands and/or ropes obtained at the end of phase 3, a polymeric and/or chemical binding resin is deposited or sprayed;
Phase 5—optional—coating with insulating material: the wires and/or the strands and/or the ropes obtained in phase 4 are coated with one more layers of polymeric and/or insulating material.

2. The process of claim 1, wherein during phase 1:
the metal wires are unrolled from a spool through a static or dynamic unrolling mechanism;
the unrolling can concern a single metallic wire or a bundle of metallic wires;
the metal wires have a circular section, with a diameter between 0.1 mm and 5 mm, but can also have a trapezoidal section;
the metal wires are made by drawing a metal chosen from the group comprising: aluminium, silver, nickel, gold, copper and/or their alloys;
preferred is aluminium.

3. The process of claim 1, wherein the polymeric material and/or the chemical binding material of step 4 contains graphene.

4. The process of claim 1, wherein at the end of phase 1, the metal wire is first subjected to the cleaning of phase 2B, then coated as described in phase 3, subsequently annealed as described in phase 2A and finally stranded and/or roped as described in phase 2C.

5. The process of claim 1, wherein at the end of phase 1, the metal wire is first subjected to the cleaning of phase 2B, then coated as described in phase 3, subsequently stranded and/or roped as described in phase 2C and finally annealed as described in phase 2A.

6. The process of claim 1, wherein at the end of phase 1, the metal wire is first subjected to phase 3 and then to phase 2.

7. The process of claim 1, wherein step 3 of phase 3 and phase 4 coexist or are alternative to each other.
